(19) United States
(12) Patent Application Publication
(10) Pub. No.: US 2004/0068420 A1
(43) Pub. Date: Apr. 8, 2004

(54) Methods and systems for facilitating tissue donation

(76) Inventor: Mark Anthony Davis, St. Charles, MO (US)

Correspondence Address: John S. Beulick, Armstrong Teasdale LLP, One Metropolitan Sq., Suite 2600, St. Louis, MO, 63102, US

(21) Appl. No.: 10/264,152

(22) Filed: Oct. 3, 2002

(51) Int. Cl. G06F 17/60

(52) U.S. Cl. 705/2

(57) ABSTRACT

A method facilitates tissue donation from an individual having at least one beneficiary. The method comprises receiving a registration from the individual during a first occasion, wherein the registration confirms the individual's consent to become a tissue donor at a subsequent second occasion, and paying at least a portion of the individual's health care expenses after receiving the registration. The method also comprises harvesting tissue from the individual during the second occasion, wherein the at least one beneficiary receives revenue based on the tissue harvested.

### BACKGROUND OF THE INVENTION

This invention relates generally to tissue donation and, more particularly, to methods and systems for facilitating tissue donation.

Despite an increase in the number of cadaveric and living donations of tissues in recent years, significant disparity exists between the supply and demand for donor tissues. At least some of this disparity may be attributable to an insufficient incentive to donate, as perceived by the public, and insufficient public awareness regarding tissue donation.

Moreover, a low rate of family consent to donation, often attributable to family members' lack of certainty about a decedent's wish to donate, has been a formidable barrier to tissue donation. At least one known method of registering donor consent involves signing a donor card in the presence of witnesses, however, at least some known organ procurement organizations (OPOs) neither receive notification that a potential donor has signed a donor card, nor consider a signed donor card as a sufficient advance directive. Therefore, despite the signed donor card, at least some known OPOs still require family consent before procuring donor tissues for transplant. The process of locating family members and securing their consent generally delays, and often prevents, the time-sensitive process of tissue procurement and transplant.

Furthermore, at least some known OPOs receive funding for arranging cadaveric donations. Many of such tissue donations are used for research within many different industries, including, but not limited to, the cosmetic industry. More specifically, the demand for cadaveric donations by such industries has exceeded the supply of such tissues, and as a result, the cost paid for such donations has increased steadily. However, the revenue received from cadaveric donations typically is not transmitted to the relatives or estate of the cadaver, but rather supplements the budget of at least some known OPOs.

### BRIEF DESCRIPTION OF THE INVENTION

In one aspect, a method for facilitating tissue donation from an individual having at least one beneficiary is provided. The method comprises receiving a registration from the individual during a first occasion, wherein the registration confirms the individual's consent to become a tissue donor at a subsequent second occasion, and paying at least a portion of the individual's health care expenses after receiving the registration. The method also comprises harvesting tissue from the individual during the second occasion, wherein the at least one beneficiary receives revenue based on the tissue harvested.

In another aspect of the invention, a tissue donation coordination system that facilitates by an intermediary tissue donation from at least one individual having at least one beneficiary is provided. The system comprises a client system comprising a browser, a data storage device for storing information relevant to the at least one individual, and a server system configured to be coupled to the client system and the data storage device. The server system is configured to receive registration information from the at least one individual during a first occasion, wherein the registration information confirms the at least one individual's consent to become a tissue donor at a subsequent second occasion, transmit signals indicative of a complete registration such that at least a portion of any health care expenses acquired during the first occasion may be paid by the intermediary, and maintain a data base of information relating the at least one individual to tissue registered to be harvested, such that at least a portion of revenue generated based on tissue harvested from the at least one individual during the second occasion, is received by the at least one beneficiary.

In a further aspect of the invention, a method for facilitating tissue donation from an individual having at least one beneficiary, using a server system that is coupled to a centralized interactive database, and at least one client system is provided. The method comprises inputting data into a centralized database in a standardized format, wherein the data includes a registration input relative to the individual during a first occasion, wherein the registration confirms the individual's consent to become a tissue donor at a subsequent second occasion, paying at least a portion of the individual's health care expenses after receiving the registration, including paying at least a portion of the individual's health care expenses in exchange for a right to harvest tissue at the second occasion, and harvesting tissue from the individual during the second occasion, wherein the at least one beneficiary receives revenue based on the tissue harvested.

### BRIEF DESCRIPTION OF THE DRAWINGS

FIG. 1 is an exemplary system block diagram for a tissue donation coordination system (TDCS);

FIG. 2 is an expanded version block diagram of an exemplary embodiment of a server architecture of the tissue donation coordination system (TDCS);

FIG. 3 illustrates an example configuration of a database within the database server of the service system including other related server components; and

FIG. 4 is a flowchart illustrating an exemplary process that may be utilized by the tissue donation coordination system (TDCS).

### DETAILED DESCRIPTION OF THE INVENTION

Exemplary embodiments of systems and processes that facilitate provision of incentives for tissue donation are described below in detail. The systems and processes facilitate, for example, electronic submission of information using a client system, automated extraction of information, and web-based reporting for internal and external system users. The tissue donation coordination system (TDCS) permits a business entity to manage and provide tissue donor (TD) information to outside authorized users, for example a next-of-kin, to assure awareness by the authorized user of an individual's pledge to donate organs or tissues.

In an exemplary embodiment, the tissue donation coordination system (TDCS) is utilized to collect, track, display, and disseminate real time information regarding tissue donation (TD) information for a registered donor. TD information includes at least one of a name of a donor, an identification number of the donor, contact information of the donor, a list of tissues pledged to be donated, a registration of donor consent for a living donation, a registration of donor consent for a cadaveric donation, a blood type of the donor, a Human Leukocyte Antigen (HLA) type for bone marrow donation, a name of a next-of-kin, contact information of the next-of-kin, a registration of family consent, and other information related to tissue donation. In addition, the TDCS enables a registered donor to review information relating to his or her pledge of tissues and indicate whether the pledge is correct. The TDCS also permits a registered donor to input information, edit information for an existing pledge, generate reports and edit security for the TDCS. Finally, the TDCS enables an authorized user, for example a next-of-kin, to review tissue donation information, as well as the donor's comments.

Tissue donation information relating to a registered donor is received by the TDCS which stores the tissue donor information in a database, updates the database with TD information received, tracks the TD information received, provides TD information in response to an inquiry, allows a registered donor to review and comment on TD information, and provides a report to at least one authorized user, for example a next-of-kin.

In the TDCS, tissue donor information is stored in the database. The network based TDCS provides convenient access to TD information, including at least one of a name of a donor, an identification number of the donor, contact information of the donor, a list of tissues pledged to be donated, a registration of donor consent for a living donation, a registration of donor consent for a cadaveric donation, a blood type of the donor, a Human Leukocyte Antigen (HLA) type for bone marrow donation, a name of a next-of-kin, contact information of the next-of-kin, a registration of family consent, and other information related to tissue donation. A user must be authorized to gain access into the TDCS. In an exemplary embodiment, the user logs onto TDCS as either a registered donor or another authorized user.

In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fully accessed by individuals having an authorized access outside the firewall of the business entity through the Internet. In a further example embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

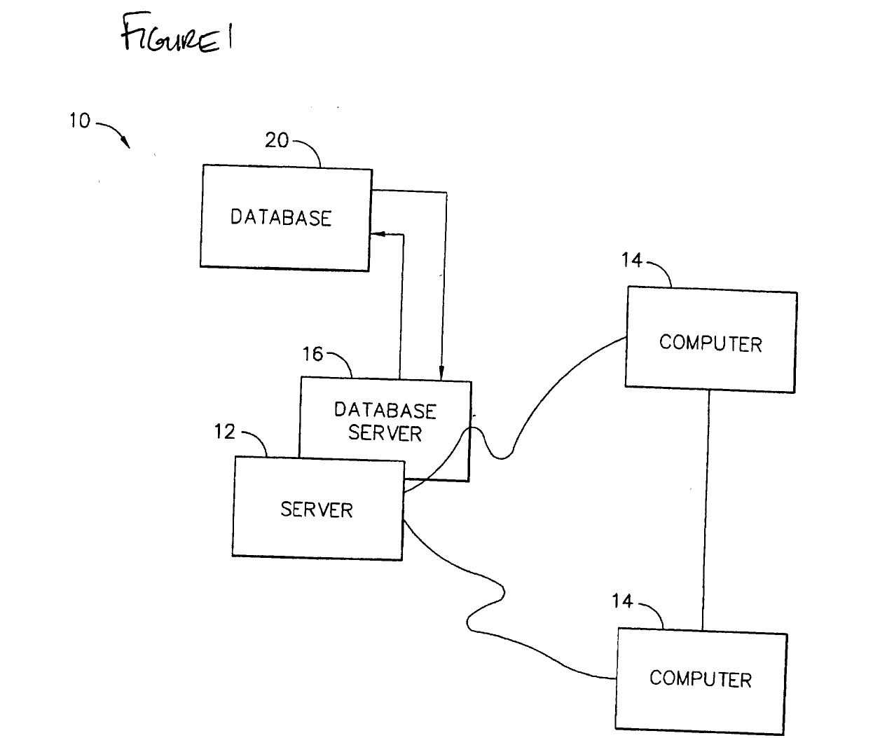

FIG. 1 is a system block diagram for a tissue donation coordination system 10 including a server system 12, and a plurality of client subsystems, also referred to as client systems 14, connected to server system 12. In one embodiment, client systems 14 are computers including a web browser, such that server system 12 is accessible to client systems 14 via the Internet. Client systems 14 are interconnected to the Internet through many interfaces including a network, such as a local area network (LAN) or a wide area network (WAN), dial-in-connections, cable modems, and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment, database 20 is stored remotely from server system 12 and may be non-centralized.

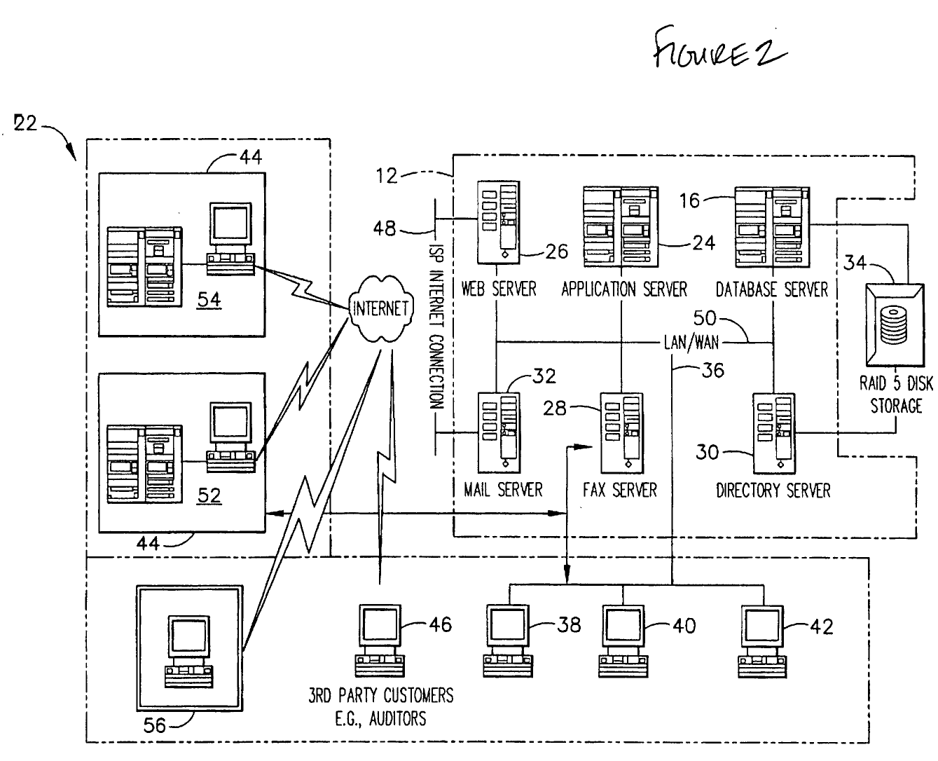

FIG. 2 is an expanded block diagram of an example embodiment of a server architecture of a tissue donation coordination system 22. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36. In an exemplary embodiment, client system 14 includes workstation 40 which can be used by a registered donor or an authorized user to review tissue donation information from the registered donor.

Server system 12 is configured to be communicatively coupled to various individuals, including employees 44 and to third parties, e.g., registered donors, authorized users, or authorized medical personnel, 46 via an ISP Internet connection 48. The communication in the example embodiment is illustrated as being performed via the Internet, however, any other wide area network (WAN) type communication can be utilized in other embodiments, i.e., the systems and processes are not limited to being practiced via the Internet. In addition, and rather than WAN 50, local area network 36 could be used in place of WAN 50.

In the exemplary embodiment, any authorized individual having a workstation 54 can access OTD 22. At least one of the client systems includes a manager workstation 56 located at a remote location. Workstation 54 and 56 are personal computers having a web browser. Also, workstations 54 and 56 are configured to communicate with server system 12. Furthermore, fax server 28 communicates with remotely located client systems, including a client system 56 via a telephone link. Fax server 28 is configured to communicate with other client systems 38, 40, and 42 as well.

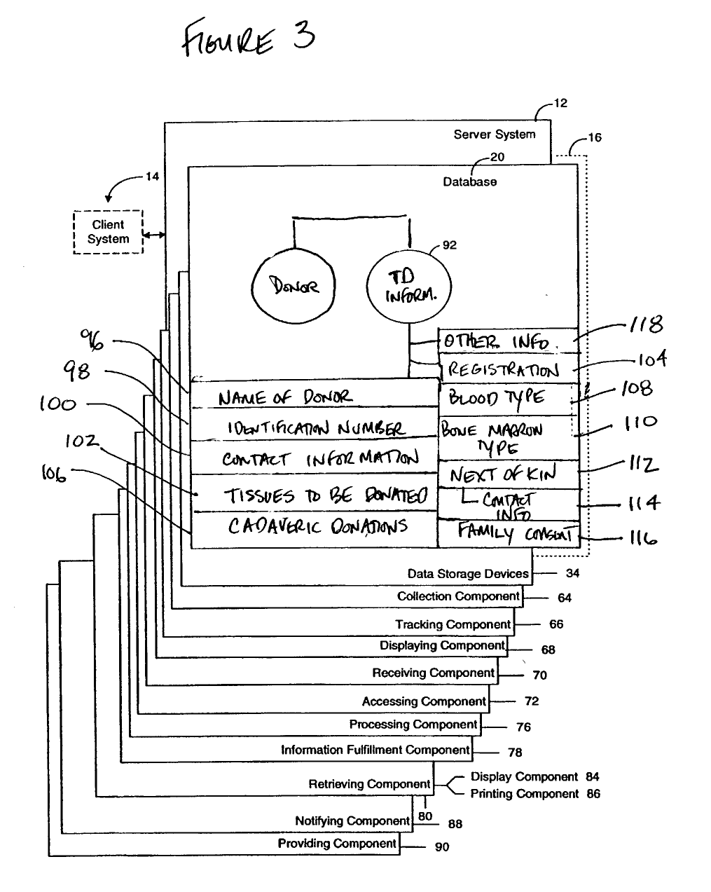

FIG. 3 illustrates an example configuration of database 20 within database server 16 of server system 12 shown in FIG. 1. Database 20 is coupled to several separate computer software components within server system 12 which perform specific tasks. In the exemplary embodiment, server system 12 includes a collection component 64 for collecting data from users in database 20, a tracking component 66 for tracking data, and a displaying component 68 to display information. Tracking component 66 tracks and cross-references data, including modifying existing data.

Server system 12 also includes a receiving component 70 to receive a specific query from client system 14, and an accessing component 72 to access database 20 within data storage device 34. Receiving component 70 is programmed to receive a query from one of a plurality of users. Server system 12 further includes processing component 76 for searching and processing received queries against database 20 containing a variety of information collected by collection component 64. An information fulfillment component 78, located in server system 12, enables the requested information to be downloaded to the plurality of users in response to the requests received by receiving component 70. Information fulfillment component 78 downloads the information after the information is retrieved from database 20 by a retrieving component 80. Retrieving component 80 retrieves, downloads, and sends information to client system 14 based on a query received from client system 14.

Retrieving component 80 also includes a display component 84 that is configured to download information to be displayed on a client system's graphical user interface and a printing component 86 that is configured to print information. Retrieving component 80 generates reports requested by the user through client system 14 in a pre-determined format. System 10 is flexible to provide other alternative types of reports and is not constrained to the options set forth above.

Server system 12 also includes a notifying component 88 and a providing component 90. Notifying component 88 electronically transmits a message to client system 14 based on information inputted into server system 12, notifying an authorized user of a review of tissue donation information by a registered donor, including the donor's comments and findings. Providing component 90 electronically provides a report to manager workstation 56 (shown in FIG. 2) summarizing the review of the tissue donation information by the registered donor, including the donor's comments.

In one embodiment, collection component 64, tracking component 66, displaying component 68, receiving component 70, processing component 76, information fulfillment component 78, retrieving component 80, display component 84, printing component 86, notifying component 88, and providing component 90 are computer programs embodied on computer readable media.

Database 20 stores tissue donation information 92 for each registered donor. TD information 92 includes at least one of a name of a donor 96, an identification number of the donor 98, contact information of the donor 100, a list of tissues pledged to be donated 102, a registration of donor consent for a living donation 104, a registration of donor consent for a cadaveric donation 106, a blood type of the donor 108, a Human Leukocyte Antigen (HLA) type for bone marrow donation 110, a name of a next-of-kin 112, contact information of the next-of-kin 114, a registration of family consent 116, and other information related to tissue donation 118.

System 10 accumulates a variety of confidential data and has different access levels to control and monitor the security of and access to system 10. Authorization for access is assigned by system administrators on a need to know basis. In one embodiment, access is provided based on whether the user is a registered donor, a next-of-kin, or a business user. The administration/editing capabilities within system 10 are also restricted to ensure that only authorized individuals have access to modify or edit the data existing in the system. System 10 manages and controls access to system data and information.

The architectures of system 10 as well as various components of system 10 are examples only. Other architectures are possible and can be utilized in connection with practicing the processes described below.

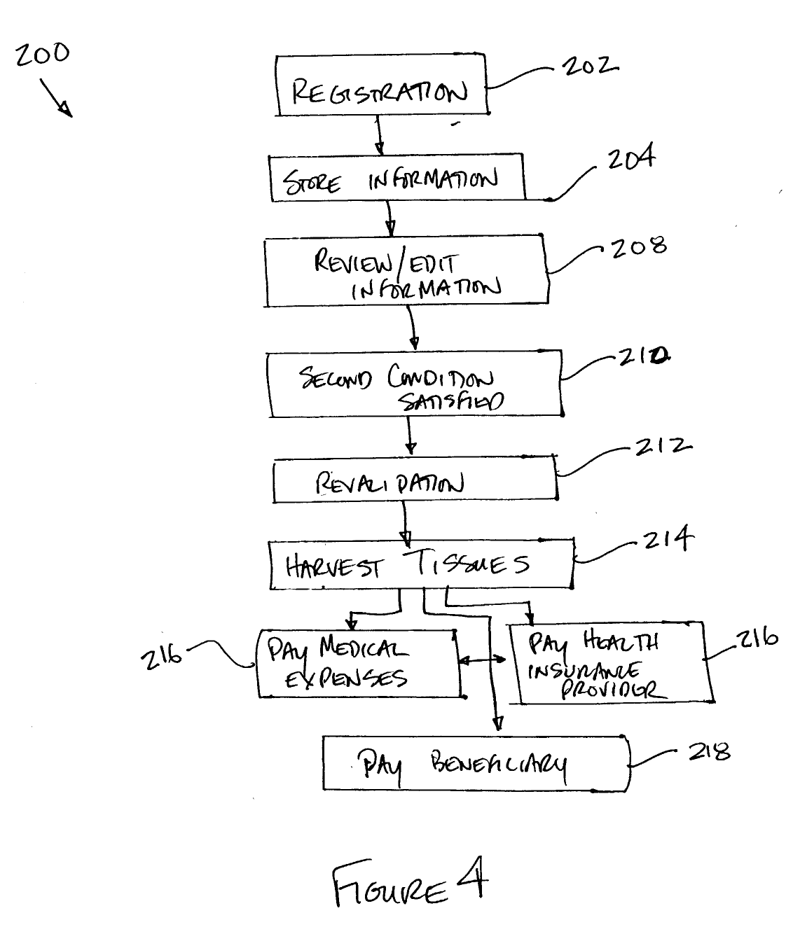

FIG. 4 is a flowchart 200 illustrating an exemplary process that may be utilized to facilitate tissue donation. In the exemplary embodiment, the process is executed using system 10. Alternatively, the process is executed without using system 10. Initially an individual requiring medical services registers 202 as a tissue donor. More specifically, registration 202 confirms the individual's consent to become a tissue donor at a subsequent second occasion, such as upon the death of the individual. In the exemplary embodiment, an intermediary organization is utilized to obtain and maintain a record of the registration.

During registration 202, tissue donor (TD) information is acquired from the potential tissue donor. Specifically, TD information may include, but is not limited to including, the name of the donor, an identification number of the donor, contact information of the donor, a list of tissues pledged to be donated, a registration of donor consent for a living donation, a registration of donor consent for a cadaveric donation, a blood type of the donor, a Human Leukocyte Antigen (HLA) type for bone marrow donation, a name of a next-of-kin, contact information of the next-of-kin, a registration of family consent, and other information related to tissue donation, including beneficiary information. It should be noted, as used herein, the term tissue refers to, but is not limited to, organs, tissues, bones, and/or bone marrow. Other TD information collected may include, but is not limited to, compatibility information, bone marrow information, and living will information.

The TD information is stored 204 in a centralized database, such as database 20, such that the TD information is readily retrievable through system 10. In addition, the centralized database enables a registered donor to review 208 information relating to his or her pledge of tissues and indicate whether the pledge is accurate. The TDCS also permits a registered donor to input information, edit information for an existing pledge, generate reports, and edit security for the TDCS. Finally, the TDCS enables an authorized user, for example a next-of-kin, to review tissue donation information, as well as the donor's comments. More specifically, in the exemplary embodiment, the individual may enter their own tissue donor information by accessing a user interface, such as a home page of the TDCS web site through client system 14 (shown in FIG. 1). In addition, as the individual is registered 202, the tissue donor information is also linked to a national tissue donor registry which includes a listing of individuals desiring tissue transplant.

In one embodiment, client system 14, as well as server system 12, are protected from access by unauthorized individuals. The individual accesses system 10 using a password (not shown) or a unique number for security. In the example embodiment, user access is based on whether the user a registered donor or another authorized user, for example a next-of-kin of the registered individual. Client system 14 transmits an electronic notice indicating to the intermediary organization that a review of tissue donation information by the registered donor has occurred, and whether the donor has any comments relating to the review.

Client system 14 displays options available to the user through links, check boxes, or pull-down lists. Once the user selects an option from the available links, the request is transmitted to server system 12 such that the database may be accessed. The requested information is provided to the user including a summary of the registered donor's tissue donation information, and any comments input by the donor.

When the individual has satisfied 210 the pre-determined conditions of the second occasion, i.e., the individual has died, a revalidation process is accomplished 212 to ensure that the original registration has not been revoked or altered. TDCS permits an individual to revoke the registration provided financial arrangements have been arranged to reimburse the health care providers and/or health insurance providers for services rendered. As such, the revalidation process also ensures that the living will and registration are still in effect.

Upon revalidation 212, tissues are harvested 214 from the individual for later use. More specifically, as previously contracted during registration, in exchange for the right to harvest tissue from the tissue donor during the second occasion, at least a portion of the individual's health care expenses and/or medical services expenses are paid 216 by the intermediary organization after the tissues have been harvested. More specifically, in exchange for the right to harvest tissue from the individual during the second occasion, at least a portion of the individual's health care expenses that are not covered by the individual's health care insurance are paid 216 by the intermediary organization to the hospital or care-provider providing the medical services, upon harvesting 214 of the tissues. As such, the health care provider and/or health insurance provider receives payment 216 for the services upon successful harvesting 214 of the tissues.

In another embodiment, health insurance providers, hospitals, health care providers, teaching institutes, and research institutes subscribe to the TDCS and are included within the centralized database. In such an embodiment, the individual registers as a tissue donor through a health insurance provider, and when the individual requires medical services, the health care provider is reimbursed 216 for the health care expenses after successful harvesting 214 of the tissues in a similar manner as described above. Because a plurality of health care providers and health insurance providers are subscribed to the TDCS, medical services to the individual are not delayed and standardized tissue-revenue trends may be stored within the centeralized database. More specifically, the TDCS also includes information regarding a plurality of training institutes, research facilities, and other facilities that desire tissue donations for, but not limited to, research and/or teaching purposes, and estimates of the amounts of revenue that may be generated based on tissue harvesting.

Any tissue deemed harvestable and in condition for transplant, is transported to the next recipient scheduled to receive a transplant that listed within the national tissue donor registry. Tissue that is harvestable, but is not considered in condition for transplant, is transported to at least one of the research institutes, teaching institutes, or facilities registered and subscribed to the TDCS.

Revenue generated based on the harvest of the non-transplantable tissue to research and/or teaching facilities is initially apportioned to reimburse at least one of the health care provider either directly, or through the health insurance provider. A portion of the revenue generated is also apportioned 218 to the beneficiaries of the tissue donor. In one embodiment, the revenue generated based on the harvest of non-transplantable tissue is a predetermined amount of revenue based on a specific tissue harvested.

The above-described tissue donation system is cost-effective and highly reliable. The tissue donation system enables a registered individual to receive medical and health care during a first occasion, in exchange for the individual consenting to be a tissue donor during a second occasion. More specifically, the tissue donation system enables at least a portion of the associated health care expenses generated by the individual during the first occasion to be paid to both the health care provider and to at least one designated beneficiary upon harvesting of the individual's tissues when the second occasion conditions have been satisfied. As a result, the individual is able to receive medical services that may have been previously unaffordable, uncovered by health insurance, or otherwise previously unavailable, in a cost-effective and reliable manner.

Exemplary embodiments of tissue donation systems and methods are described above in detail. The systems and methods are not limited to the specific embodiments described herein, but rather, components and aspects of each method and system may be utilized independently and separately from other components and aspects described herein. Each tissue donation system component can also be used in combination with other tissue donation system components.

While the invention has been described in terms of various specific embodiments, those skilled in the art will recognize that the invention can be practiced with modification within the spirit and scope of the claims.

What is claimed is:

1. A method for facilitating tissue donation from an individual having at least one beneficiary, said method comprising:
receiving a registration from the individual during a first occasion, wherein the registration confirms the individual's consent to become a tissue donor at a subsequent second occasion;
paying at least a portion of the individual's health care expenses after receiving the registration; and
harvesting tissue from the individual during the second occasion, wherein the at least one beneficiary receives revenue based on the tissue harvested.

2. A method in accordance with claim 1 wherein paying at least a portion of the individual's health care expenses after receiving the registration further comprises paying at least a portion of the individual's health care expenses in exchange for a right to harvest tissue at the second occasion.

3. A method in accordance with claim 1 wherein receiving a registration from the individual during a first occasion further comprises receiving at an intermediary the registration from the individual during the first occasion, wherein the intermediary is further configured to:
pay at least a portion of the individual's health care expense in exchange for a right to harvest tissue at the second occasion;
receive revenue based on the tissue harvested; and
pay a portion of the revenue received to the at least one beneficiary.

4. A method in accordance with claim 3 wherein receiving at an intermediary the registration from the individual during the first occasion further comprises maintaining a database comprising information for identifying the individual and the tissue that the individual has registered for harvest.

5. A method in accordance with claim 4 wherein maintaining a database further comprises maintaining a database comprising information identifying at least one of research institutes, teaching institutes, and hospitals.

6. A method in accordance with claim 4 wherein maintaining a database further comprises maintaining a database comprising information relating the individual to at least one beneficiary,

7. A method in accordance with claim 3 wherein harvesting tissue from the individual during the second occasion further comprises harvesting tissue from the individual that is not suitable for transplant to another individual.

8. A method in accordance with claim 3 further comprising delivering harvested tissue to an institution for use within at least one of research and teaching.

9. A method in accordance with claim 3 further comprising reimbursing at least one of medical personal and a hospital for health care expenses accumulated during the second occasion.

10. A method in accordance with claim 3 further comprising establishing a schedule relating tissues that may be harvested with predetermined revenue amounts.

11. A method in accordance with claim 3 wherein harvesting tissue from the individual during the second occasion further comprises determining if the harvested tissue is viable for transplant to another individual.

12. A method in accordance with claim 11 wherein determining if the harvested tissue is viable for transplant to another individual further comprises contacting a proposed transplant recipient based on an established national tissue transplant registry.

14. A tissue donation coordination system for facilitating by an intermediary tissue donation from at least one individual having at least one beneficiary, said system comprising:
a client system comprising a browser;
a data storage device for storing information relevant to the at least one individual; and
a server system configured to be coupled to said client system and said data storage device, said server system further configured to:
receive registration information from the at least one individual during a first occasion, wherein the registration information confirms the at least one individual's consent to become a tissue donor at a subsequent second occasion;
transmit signals indicative of a complete registration such that at least a portion of any health care expenses acquired during the first occasion may be paid by the intermediary; and
maintain a data base of information relating the at least one individual to tissue registered to be harvested, such that at least a portion of revenue generated based on tissue harvested from the at least one individual during the second occasion, is received by the at least one beneficiary.

15. A system in accordance with claim 14 wherein said server system further configured to maintain a data base of information relating the at least one individual to tissue registered to be harvested, such that at least a portion of revenue generated based on tissue harvested from the at least one individual during the second occasion, is used to pay for at least a portion of the individual's health care expenses in exchange for a right to harvest tissue at the second occasion.

16. A system in accordance with claim 15 wherein said server system further configured to maintain a database comprising information identifying at least one of research institutes, teaching institutes, and hospitals.

17. A system in accordance with claim 15 wherein said server system further configured to maintain a database comprising information relating the at least one individual to the at least one beneficiary,

18. A system in accordance with claim 15 wherein said server system further configured to maintain a data base comprising information relating to harvested tissues.

19. A system in accordance with claim 15 wherein said server system further configured to maintain a data base comprising information relating to at least one institution that uses harvested tissue for at least one of research and teaching.

20. A method for facilitating tissue donation from an individual having at least one beneficiary, using a server system that is coupled to a centralized interactive database, and at least one client system, said method comprising:
inputting data into a centralized database in a standardized format, wherein the data includes a registration input relative to the individual during a first occasion, wherein the registration confirms the individual's consent to become a tissue donor at a subsequent second occasion;
paying at least a portion of the individual's health care expenses after receiving the registration, including paying at least a portion of the individual's health care expenses in exchange for a right to harvest tissue at the second occasion.; and
harvesting tissue from the individual during the second occasion, wherein the at least one beneficiary receives revenue based on the tissue harvested.

21. A method in accordance with claim 20 wherein inputting data into a centralized database further comprises inputting data into the centralized database that is relative to at least one of research institutes, teaching institutes, and hospitals.

22. A method in accordance with claim 20 wherein inputting data into a centralized database further comprises inputting data into the centralized database that correlates each individual with the at least one beneficiary,

23. A method in accordance with claim 20 wherein harvesting tissue from the individual during the second occasion further comprises harvesting tissue from the individual that is not suitable for transplant to another individual.

24. A method in accordance with claim 20 further comprising reimbursing at least one of medical personal and a hospital for health care expenses accumulated during the second occasion.

25. A method in accordance with claim 24 further comprising delivering harvested tissue to an institution for purposes comprising at least one of research and teaching.
